(19) United States
(12) Patent Application Publication
(10) Pub. No.: US 2010/0033577 A1
(43) Pub. Date: Feb. 11, 2010

(54) VIDEO SURVEILLANCE AND REMOTE MONITORING

(75) Inventors: Jeffrey Doak, Senecaville, OH (US); Bryon Taylor, Senecaville, OH (US)

Correspondence Address: BENESCH, FRIEDLANDER, COPLAN & ARONOFF LLP;ATTN: IP DEPARTMENT DOCKET CLERK, 200 PUBLIC SQUARE, SUITE 2300, CLEVELAND, OH, 44114-2378, US

(73) Assignee: I2C TECHNOLOGIES, LTD., Uniontown, OH (US)

(21) Appl. No.: 12/536,351

(22) Filed: Aug. 5, 2009

Related U.S. Application Data
(60) Provisional application No. 61/086,468, filed on Aug. 5, 2008.

(51) Int. Cl. H04N 7/18

(52) U.S. Cl. 348/159; 348/E07.085

(57) ABSTRACT

A housing for at least three adjustably fixed cameras and at least one pan/tilt/zoom camera may include a bottom wall having a bottom opening and a dome protruding through the bottom opening, where the dome may be configured to house at least a portion of the at least one pan/tilt/zoom camera. The housing may further include a number of side walls including first, second, and third side walls adjacent to the bottom wall and disposed at obtuse angles in reference to the bottom wall. The first, second and third side walls may also have openings disposed in line with the viewing angles of the fixed cameras. The housing may also include a fourth side wall adjacent to the bottom wall.

### CROSS REFERENCE TO RELATED APPLICATIONS

This application claims the benefit of Provisional Application 61/086,468 filed Aug. 5, 2008, which is incorporated herein by reference.

### FIELD OF THE INVENTION

This application relates to video surveillance systems and in particular to surveillance systems configured to be remote, mobile, self contained, and provide advanced surveillance, monitoring, and video archiving features.

### BACKGROUND

Conventional video surveillance systems may monitor one or more camera views, which may be monitored by a person or recorded for later retrieval. A surveillance system implementation that relies on a person monitoring multiple camera views must have the person on duty at all times. A video surveillance system implementation relying on recorded video such as VCR or DVR must be configured to record all camera views at all times. Large amounts of video tape or digital storage space are required. If the system is configured to multiplex between different cameras to save recording resources, important events may be missed.

Moreover, after-the-fact searching of video for particular events or times may require a person to watch many hours of video to find the event or time of interest. During an after-the-fact investigation of, for example, a burglary where time may be of the essence, the time required for a person to watch the necessary length of video to find the event or time of interest may be significant. Even if the system provided the person with the ability to cue to a particular time, the person may not know the exact time at which the event occurred.

Conventional video surveillance systems may be fixed to infrastructure such as buildings or posts, and may require cabling to connect to monitoring equipment. These fixed systems may take significant time and resources to deploy.

### BRIEF DESCRIPTION OF THE DRAWINGS

The accompanying drawings, which are incorporated in and constitute a part of the specification, illustrate example systems, components, and so on, that illustrate various example embodiments of aspects of the invention. It will be appreciated that the illustrated element boundaries (e.g., boxes, groups of boxes, or other shapes) in the figures represent one example of the boundaries. One of ordinary skill in the art will appreciate that one element may be designed as multiple elements or that multiple elements may be designed as one element. An element shown as an internal component of another element may be implemented as an external component and vice versa. Furthermore, elements may not be drawn to scale.

FIG. 1 illustrates a front top right angle view of an example video surveillance and remote monitoring system.

FIG. 2 illustrates a front top right angle view of the example video surveillance and remote monitoring system.

FIG. 3 illustrates a front top left angle view of the example video surveillance and remote monitoring system.

FIG. 4 illustrates a back top left angle view of the example video surveillance and remote monitoring system.

FIG. 5 illustrates a block diagram of the example surveillance and monitoring system.

### DETAILED DESCRIPTION

The following includes definitions of selected terms employed herein. The definitions include various examples or forms of components that fall within the scope of a term and that may be used for implementation. The examples are not intended to be limiting. Both singular and plural forms of terms may be within the definitions.

As used in this application, the term “computer component” refers to a computer-related entity: hardware, firmware, software, a combination thereof, or software in execution. For example, a computer component can be, but is not limited to being, a process running on a processor, a processor, an object, an executable, a thread of execution, a program, and a computer. By way of illustration, both an application running on a server and the server can be computer components. One or more computer components can reside within a process or thread of execution and a computer component can be localized on one computer or distributed between two or more computers.

“Computer communication,” as used herein, refers to a communication between two or more computing devices (e.g., computer, personal digital assistant, cellular telephone) and can be, for example, a network transfer, a file transfer, an applet transfer, an email, a hypertext transfer protocol (HTTP) transfer, and so on. A computer communication can occur across, for example, a wireless system (e.g., IEEE 802.11, IEEE 802.15), an Ethernet system (e.g., IEEE 802.3), a token ring system (e.g., IEEE 802.5), a local area network (LAN), a wide area network (WAN), a point-to-point system, a circuit switching system, a packet switching system, combinations thereof, and so on.

“Computer-readable medium” or “CRM” as used herein, refers to a medium that participates in directly or indirectly providing signals, instructions, or data. A computer-readable medium may take forms, including, but not limited to, non-volatile media, volatile media, and transmission media. Non-volatile media may include, for example, optical or magnetic disks, and so on. Volatile media may include, for example, optical or magnetic disks, dynamic memory, and the like. Transmission media may include coaxial cables, copper wire, fiber optic cables, and the like. Transmission media can also take the form of electromagnetic radiation, like that generated during radio-wave and infra-red data communications, or take the form of one or more groups of signals. Common forms of a computer-readable medium include, but are not limited to, a floppy disk, a flexible disk, a hard disk, a magnetic tape, other magnetic media, a CD-ROM, other optical media, punch cards, paper tape, other physical media with patterns of holes, a RAM, a ROM, an EPROM, a FLASH-EPROM, or other memory chip or card, a memory stick, a carrier wave/pulse, and other media from which a computer, a processor or other electronic device can read. Signals used to propagate instructions or other software over a network, like the Internet, can be considered a “computer-readable medium.”

“Data store,” as used herein, refers to a physical or logical entity that can store data. A data store may be, for example, a database, a table, a file, a list, a queue, a heap, a memory, a register, and so on. A data store may reside in one logical or physical entity or may be distributed between two or more logical or physical entities.

“Logic,” as used herein, includes but is not limited to hardware, firmware, software, or combinations of each to perform a function(s) or an action(s), or to cause a function or action from another logic, method, or system. For example, based on a desired application or needs, logic may include a software controlled microprocessor, discrete logic like an application specific integrated circuit (ASIC), a programmed logic device, a memory device containing instructions, or the like. Logic may include one or more gates, combinations of gates, or other circuit components. Logic may also be fully embodied as software. Where multiple logical logics are described, it may be possible to incorporate the multiple logics into one physical logic. Similarly, where a single logical logic is described, it may be possible to distribute that single logical logic between multiple physical logics.

An “operable connection,” or a connection by which entities are “operably connected,” is one in which signals, physical communications, or logical communications may be sent or received. Typically, an operable connection includes a physical interface, an electrical interface, or a data interface, but it is to be noted that an operable connection may include differing combinations of these or other types of connections sufficient to allow operable control. For example, two entities can be operably connected by being able to communicate signals to each other directly or through one or more intermediate entities like a processor, an operating system, a logic, software, or other entity. Logical or physical communication channels can be used to create an operable connection.

“Query,” as used herein, refers to a semantic construction that facilitates gathering and processing information. A query might be formulated in a database query language like structured query language (SQL) or object query language (OQL). A query might be implemented in computer code (e.g., C#, C++, Javascript) that can be employed to gather information from various data stores or information sources.

“Signal,” as used herein, includes but is not limited to one or more electrical or optical signals, analog or digital signals, data, one or more computer or processor instructions, messages, a bit or bit stream, or other means that can be received, transmitted or detected.

“Software,” as used herein, includes but is not limited to, one or more computer or processor instructions that can be read, interpreted, compiled, or executed and that cause a computer, processor, or other electronic device to perform functions, actions or behave in a desired manner. The instructions may be embodied in various forms like routines, algorithms, modules, methods, threads, or programs including separate applications or code from dynamically or statically linked libraries. Software may also be implemented in a variety of executable or loadable forms including, but not limited to, a stand-alone program, a function call (local or remote), a servelet, an applet, instructions stored in a memory, part of an operating system or other types of executable instructions. It will be appreciated by one of ordinary skill in the art that the form of software may depend, for example, on requirements of a desired application, the environment in which it runs, or the desires of a designer/programmer or the like. It will also be appreciated that computer-readable or executable instructions can be located in one logic or distributed between two or more communicating, co-operating, or parallel processing logics and thus can be loaded or executed in serial, parallel, massively parallel and other manners.

Suitable software for implementing the various components of the example systems and methods described herein may be produced using programming languages and tools like Java, Pascal, C#, C++, C, CGI, Perl, SQL, APIs, SDKs, assembly, firmware, microcode, or other languages and tools. Software, whether an entire system or a component of a system, may be embodied as an article of manufacture and maintained or provided as part of a computer-readable medium as defined previously. Another form of the software may include signals that transmit program code of the software to a recipient over a network or other communication medium. Thus, in one example, a computer-readable medium has a form of signals that represent the software/firmware as it is downloaded from a web server to a user. In another example, the computer-readable medium has a form of the software/firmware as it is maintained on the web server. Other forms may also be used.

“User,” as used herein, includes but is not limited to one or more persons, software, computers or other devices, or combinations of these.

Some portions of the detailed descriptions that follow are presented in terms of algorithms and symbolic representations of operations on data bits within a memory. These algorithmic descriptions and representations are the means used by those skilled in the art to convey the substance of their work to others. An algorithm is here, and generally, conceived to be a sequence of operations that produce a result. The operations may include physical manipulations of physical quantities. Usually, though not necessarily, the physical quantities take the form of electrical or magnetic signals capable of being stored, transferred, combined, compared, and otherwise manipulated in a logic and the like.

It has proven convenient at times, principally for reasons of common usage, to refer to these signals as bits, values, elements, symbols, characters, terms, numbers, or the like. It should be borne in mind, however, that these and similar terms are to be associated with the appropriate physical quantities and are merely convenient labels applied to these quantities. Unless specifically stated otherwise, it is appreciated that throughout the description, terms like processing, computing, calculating, determining, displaying, or the like, refer to actions and processes of a computer system, logic, processor, or similar electronic device that manipulates and transforms data represented as physical (electronic) quantities.

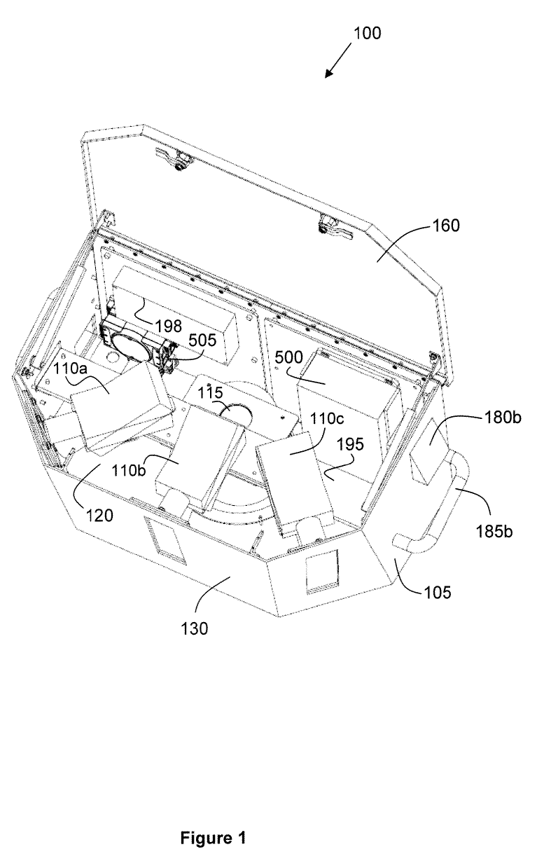

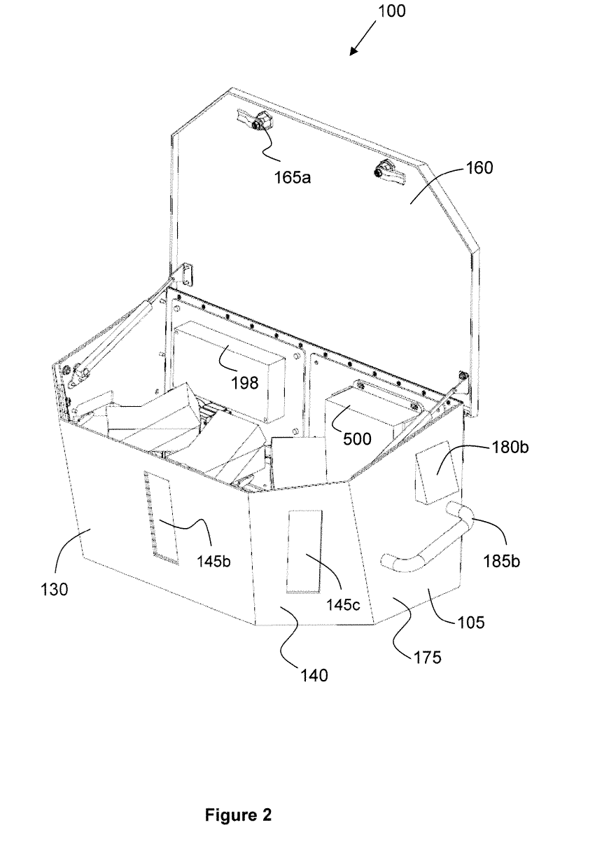

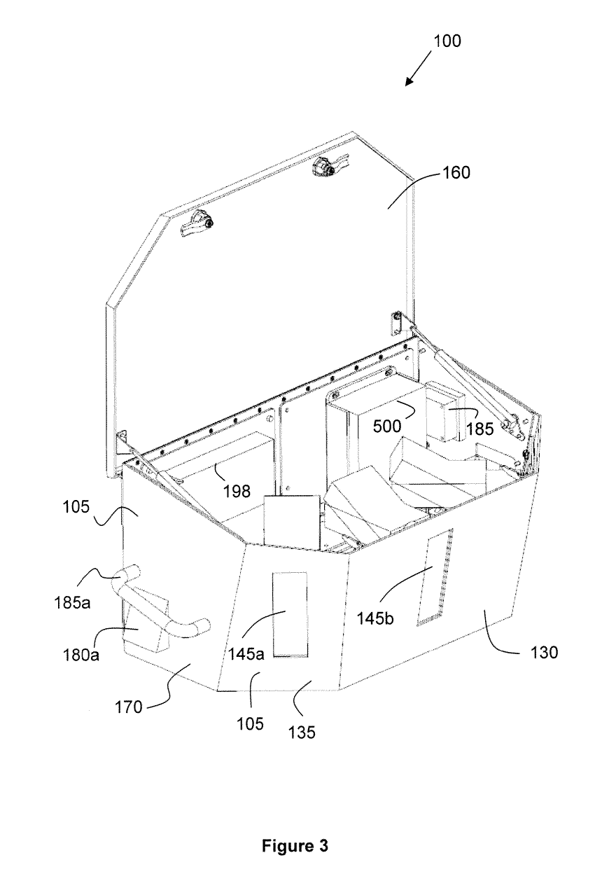

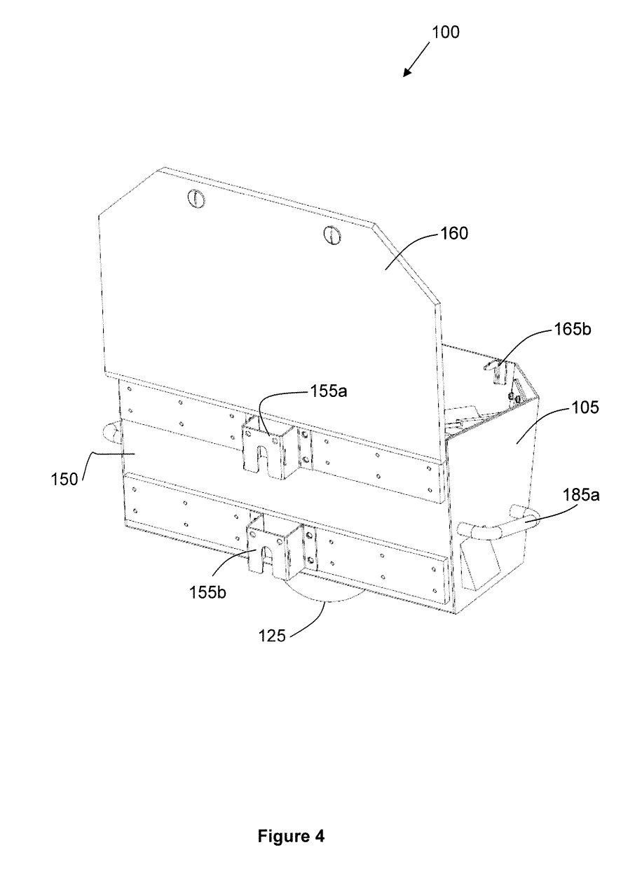

FIGS. 1-4 illustrate various views of an example video surveillance and monitoring system 100. System 100 may include a housing 105. In one embodiment, housing 105 may be configured to house three fixed cameras 110a-c. In some embodiments, fixed cameras 110a-c may provide views around system 100 of up to 300 degrees. Cameras 110a-c may be adjustable up and down to aim the cameras at a desired target. In one embodiment, housing 105 may be configured to also house a pan/tilt/zoom (PTZ) camera 115. PTZ camera 115 may rotate 360 degrees around an axis of rotation of system 100. Housing 105 may include a bottom wall 120 having a bottom opening (not shown). Housing 105 may also include a dome 125, which protrudes through the bottom opening. Dome 125 may house at least a portion of pan/tilt/zoom camera 115.

Housing 105 includes a plurality of side walls. In one embodiment, housing 105 includes six side walls. In other embodiments, housing 105 may include any multiple number of walls. In one embodiment, housing 105 three side walls: a first side wall 130, a second side wall 135, and a third side wall 140. These three side walls may have openings 145a-c in front of or in line with the viewing angles of cameras 110a-c such that cameras 110a-c may have a substantially unobstructed view through openings 145a-c. Cameras 110a-c may be adjustable up and down along the length of openings 145a-c. Housing 105 may also include shields mounted in front or behind openings 145a-c to protect cameras 110a-c from any objects or weather. Dome 125 and the shields may be made from a material suitable for the application (e.g. ballistic grade polycarbonate, polycarbonate, acrylic, styrene, glass, and so on). First side wall 130, second side wall 135, and third side wall 140 may be adjacent to bottom wall 120 and at an angle larger than 90 degrees but smaller than 180 degrees in reference to bottom wall 120. In one embodiment, first side wall 130, second side wall 135, and third side wall 140 may be at a 100 degrees angle in reference to bottom wall 120. The angled position of these three side walls may assist in keeping rain off the shields providing better visibility for cameras 110a-c. The angled position of these three side walls may also provide cameras 110a-c with a better viewing angle in applications where housing 105 is mounted above the intended target.

In one embodiment, housing 105 includes a fourth side wall 150. Fourth side wall 150 may include or may have attached mounting brackets 155a-b. In one embodiment, fourth side wall 150 may include or have attached only one mounting bracket or more than two mounting brackets. Mounting brackets 155a-b may be of a kind that allows for housing 105 to be easily installed by brackets 155a-b sliding the brackets into a pair of bolts, for example. Fourth side wall 150 may further include or have attached reinforcement bars along its width to reinforce fourth side wall 150 and distribute the weight of housing 105 across fourth side wall 150 when housing 105 is installed hanging from brackets 155a-b.

Housing 105 may include a top wall 160. Top wall 160 may be connected by hinges to one or more of the side walls to form a top door for housing 105. Housing 105 may include a locking mechanism 165a-b to lock top wall 160. The locking mechanism may include multiple members with some of the members mounted to top wall 160 and other members mounted to one or more of the side walls.

In one embodiment, housing 105 includes a fifth side wall 170 and a sixth wall 175. Fifth side wall 170 may be adjacent to bottom wall 120, second side wall 135, and fourth side wall 150. Sixth side wall 175 may be adjacent to bottom wall 120, third side wall 140, and fourth side wall 150. In one embodiment, fifth side wall 170 and sixth side wall 175 may have vent openings 180a-b that allow air to flow in and out of housing 105 to cool down electronics enclosed by housing 105. Housing 105 may also include a fan 185 mounted to fifth side wall 170 or to sixth side wall 175. Fan 185 may be installed in line with either vent 180a or 180b to at least assist in circulating air into and out of housing 105 trough vents 180a and 180b. Housing 105 may also include handles 185a-b mounted to two or more of the side walls. In one embodiment, handle 185a is mounted to fifth side wall 170 and handle 185b is mounted to sixth side wall 175. A user may use handles 185a-b to lift housing 105, making movement of housing 105 easier.

In one embodiment, housing 105 including the multiple walls is made of aluminum. In other embodiments, housing 105 may be made of other suitable materials or a combination of materials (metals, polymers, and so on).

In one embodiment, housing 105 includes a camera mounting bracket 195, which may mount inside housing 105. Camera mounting bracket 195 may be configured to accept mounting mechanisms from fixed cameras 110a-c and pan/tilt/zoom camera 115. The cameras may be secured to bracket 195, which in turn may be secured inside housing 105. This construction allows for all the cameras to first be mounted to camera mounting bracket 195 while outside of housing 105 The complete assembly mat then be inserted and secured in housing 105.

In one embodiment, system 100 may include electronic circuitry including a processor or central processing unit in a CPU box 500 housed inside housing 105. Housing 105 may also house power supply 198 and input/output interfaces 505. Power supply 198 may operate to provide power to the electronics inside housing 105 including CPU box 500 and the cameras.

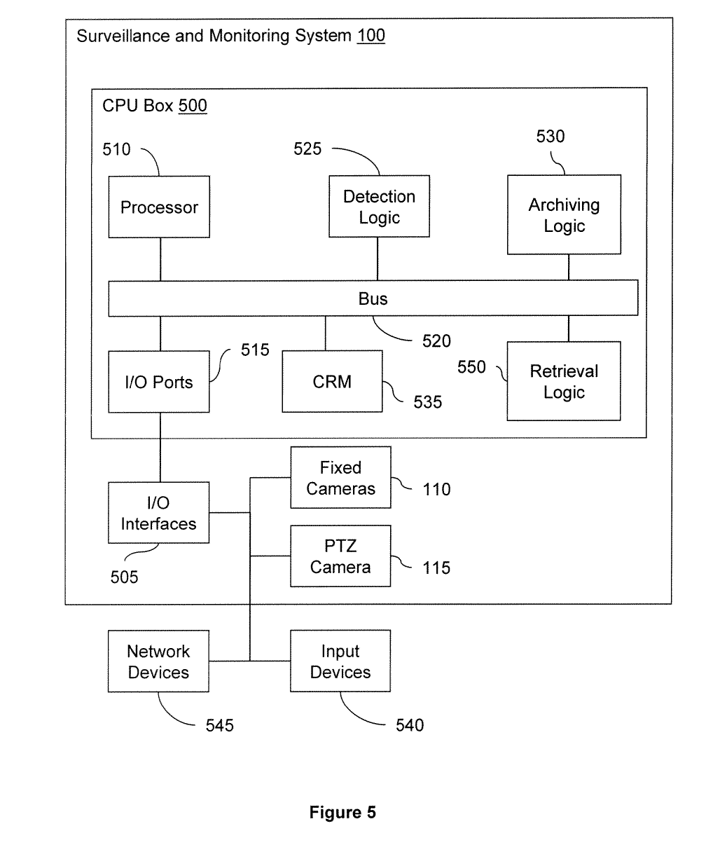

FIG. 5 illustrates an example surveillance and monitoring system 100 that may include a CPU box 500, fixed cameras 110 and a pan/tilt/zoom camera 115. In CPU box 500, system 100 may include a processor 510, I/O Ports 515 operably connected by a bus 520, detection logic 525, archiving logic 530, and computer readable medium (CRM) 535.

In one example, system 100 may include detection logic 525 configured to communicate with input devices 540 via I/O Interfaces 505. Input devices 540 may be microphones, motion detectors, sound detectors, infrared beams, and so on. For example, if input devices 540 included a motion detector, upon the motion detector detecting motion in the area of the motion detector, the detection logic 525 may receive a signal from the motion detector via I/O Interfaces 505 and I/O Ports 515. Detection logic 525 is further configured to communicate with network devices 545 and cameras 110 and 115 to, for example, aim camera 115 at a particular area depending on a detected event. Detection logic 525 may also be programmed to detect an absolute or relative time.

In one embodiment, detection logic 525 may detect the occurrence of a triggering event from a signal received from one or more of the three fixed cameras 110. Upon detection of this triggering event, detection logic 525 may communicate a signal to pan/tilt/zoom camera 115 to zoom-in in the direction of the triggering event. In other embodiments, triggering events may include events based on logic, business systems such as point of sale events, or chain of events. Upon detection of any one of these events, or a combination of events, detection logic 525 may cause cameras including PTZ camera 115 to capture still images or video.

Analytics logic (not shown) in combination with cameras 110 and 115 may also act as an input device that would send a signal to detection logic 525 upon the analytics logic detecting a specific behavior or activity in the video captured by the cameras. The behaviors that may be detected by the analytics logic include movement in a zone of interest, a person or vehicle crossing a predetermined line, a person or vehicle crossing a perimeter, a number of persons or vehicles have gone by an area, a person or vehicle is being followed through a secured entry point, persons loitering, persons grouping, crowd gathering, person slipping and falling, a person spending excessive time in an area, movement of a vessel on water surface, objects left behind for a specified amount of time, a vehicle parked for a specified amount of time, an object or vehicle obstructing a road way or tracks, an object removed from an area, and so on.

Thus, detection logic 525, whether implemented in system 100 as hardware, firmware, software, or a combination, may provide means for detecting the occurrence of a triggering event and for acting upon the event.

Acting upon the triggering event may include, for example, setting off an alarm to alert users of the occurrence of the event. In this example, system 100 may communicate with network devices 545 via a signal from detection logic 525 and activate the alarm. A person having ordinary skill in the art would understand that the signal from the detection logic 525 may be connected to a virtually infinite number of different network devices 545 to produce different results based on the event detected by the detection logic 525. Other examples may be closing a door, turning on a light, starting a motor, sending an email, or signaling archiving logic 530.

System 100 may include archiving logic 530, which may cause the system 100 to archive in CRM 535, among other information, images, sound, or video captured by cameras 110 and 115. Still images captured by the cameras may be compressed in various formats including jpeg, and so on. Video captured by the cameras may be compressed in various formats including mpeg-4, and so on. Upon detection logic 525 detecting a signal from input devices 540, detection logic 525 may send a signal to archiving logic 530 to archive in CRM 535 the images or video received from cameras 110 and 115. The images, sound, or video may be archived in a data store such as a database, together with identifying information such as the name or identification of the triggering event or input device, time and date, camera name, camera position, and so on. Archiving logic 530 archives the images or video in relation to the identifying information in such a way that would permit later retrieval of the images or video by use of a query for the identifying information. Thus, for example, the analytics logic may detect a person crossing a perimeter. Detection logic 525 may receive a signal indicating the crossing. An alarm may be emitted to alert of the intruder. At a later time, a user may retrieve video or images of the intrusion by querying the database for crossings of the perimeter.

CRM 535 may be operably connected to system 100 via, for example, I/O Interfaces (e.g., card, device, and so on) 505 and I/O Ports 515. Processor 510 may be a variety of various processors including dual microprocessor and other multi-processor architectures.

System 100 may also incorporate retrieval logic 550. A user may retrieve images or video archived in CRM 535 by using retrieval logic 550. Retrieval logic 550 may work in conjunction with I/O devices or interfaces 505 for the user to query the data store containing the still images or video. Since archiving logic 530 archived the images or video and the identifying information in such a way that would permit later retrieval of the images or video by use of a query for the identifying information, the user may effectively and efficiently query the data store with the identifying information to retrieve the images or video. For example, a user may use retrieval logic 550 to query the database for a specific time and date, and retrieval logic 550 would return images or video corresponding to the time or date queried. A user may also query the database with the name of the input device that triggered archiving of the video segment or images.

Moreover, if system 100 used as an input device, for example, analytics logic in combination with cameras 110 and 115, a user may use retrieval logic 550 to query the database for identifying information regarding, for example, behavior of a subject captured on video by the cameras. For example, if the analytics were programmed to detect a subject loitering in a parking lot, once the analytics detect the behavior, loitering, through analysis of the video captured by camera 110 or 115, the analytics logic would transmit a signal to detection logic 525, which in turn would cause archiving logic 530 to begin archiving the captured video. Archiving logic 530 archives the captured video with identifying information that would identify the archived video as a loitering incident. Thus, a user may later retrieve the video by use of retrieval logic 550. The user would query the database for, for example, the term “loitering” and the date, which would return all loitering incidents on that date.

Retrieval logic 550 may be configured with a set of search filters so that a user may select filters to find a video segment or image of interest to the user based on the selected filters. Retrieval logic 550 may also present to the user a still image or thumbnail of each archived video segment so that the user may efficiently sift through archived segments for the one of interest to the user.

Bus 520 can be a single internal bus interconnect architecture or other bus or mesh architectures. While a single bus is illustrated, it is to be appreciated that system 100 may communicate with various other devices and logics using other busses that are not illustrated (e.g., PCIE, SATA, Infiniband, 1394, USB, Ethernet). Bus 520 can be of a variety of types including, but not limited to, a memory bus or memory controller, a peripheral bus or external bus, a crossbar switch, or a local bus. The local bus can be of varieties including, but not limited to, an industrial standard architecture (ISA) bus, a microchannel architecture (MCA) bus, an extended ISA (EISA) bus, a peripheral component interconnect (PCI) bus, a universal serial (USB) bus, and a small computer systems interface (SCSI) bus.

System 100 may interact with additional input/output devices via I/O Interfaces 505 and I/O Ports 515. Input/output devices can include, but are not limited to, a keyboard, a microphone, a pointing and selection device, video cards, displays, disks, and so on. The I/O Ports 515 can include but are not limited to, serial ports, parallel ports, and USB ports. In one embodiment, I/O Ports 515 may communicate with input devices 540 via I/O Interfaces 505 using known communication protocols such as Controller Area Network (CAN), Modbus, ZigBee, Ethernet Global Data (EGD), SERCOS, and so on.

System 100 can operate in a network environment and thus may be connected to network devices 545 via I/O Interfaces 505, or the I/O Ports 515. Through the network, system 100 may be logically connected to remote computers. The networks with which system 100 may interact include, but are not limited to, a local area network (LAN), a wide area network (WAN), and other networks such as the Internet. Network devices 545 can connect to LAN technologies including, but not limited to, fiber distributed data interface (FDDI), copper distributed data interface (CDDI), Ethernet (IEEE 802.3), token ring (IEEE 802.5), wireless computer communication (IEEE 802.11), Bluetooth (IEEE 802.15.1), Zigbee (IEEE 802.15.4) and so on. Similarly, network devices 545 may have cellular connectivity or may connect to WAN technologies including, but not limited to, point to point links, circuit switching networks like integrated services digital networks (ISDN), packet switching networks, and digital subscriber lines (DSL). While individual network types are described, it is to be appreciated that communications via, over, or through a network may include combinations and mixtures of communications. For example, a user seeking to adjust cameras 110 may make use of a 2.4 GHz communication signal to see via a handheld device the view of any one of cameras 110. The user may then adjust one or more of the cameras to a desired position based on the user observing in the handheld device the current view being received by the camera.

When system 100 is connected to remote computers via the network, a user at a remote computer may access still images or video captured by cameras 110 and 115 live or the user may access the archived images or video remotely via retrieval logic 550 which may be accessible via a user interface such as a web browser at the remote computer. Further, connection to a network may provide system 100 with an internet connection where a user may view camera views real time and archived images or video from anywhere using a web browser. Thus, a user may be able to monitor the surveillance area at a safe distance from the system 100. A user may also use input devices such as a joystick to control the camera 115 pan, tilt, and zoom. Moreover, when system 100 is connected to a network, system 100 may be made to send, for example, email or text message to alert a remote user of a detected condition. System 100 may also be accessed remotely to, for example, determine the health of the system, diagnose system failure, and so on. Such remote access may be conditioned on the remote user being authenticated by the use of a password. System 100 while connected to a network may also automatically receive software updates from authenticated sources.

While example systems, methods, and so on, have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and so on, described herein. Additional advantages and modifications will readily appear to those skilled in the art. Therefore, the invention is not limited to the specific details, the representative apparatus, and illustrative examples shown and described. Thus, this application is intended to embrace alterations, modifications, and variations that fall within the scope of the appended claims. Furthermore, the preceding description is not meant to limit the scope of the invention. Rather, the scope of the invention is to be determined by the appended claims and their equivalents.

To the extent that the term “includes” or “including” is employed in the detailed description or the claims, it is intended to be inclusive in a manner similar to the term “comprising” as that term is interpreted when employed as a transitional word in a claim. Furthermore, to the extent that the term “or” is employed in the detailed description or claims (e.g., A or B) it is intended to mean “A or B or both”. When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

1. A housing for at least three adjustably fixed cameras including a first adjustably fixed camera, a second adjustably fixed camera, and a third adjustably fixed camera and at least one pan/tilt/zoom camera, the housing comprising:
a bottom wall having a bottom opening;
a dome protruding through the bottom opening, the dome being configured to house at least a portion of the at least one pan/tilt/zoom camera;
at least four side walls including:
a first side wall adjacent to the bottom wall and disposed at an obtuse angle in reference to the bottom wall, the first side wall having a first opening disposed in line with a viewing angle of the first adjustably fixed camera from the at least three adjustably fixed cameras;
a second side wall adjacent to the first side wall and the bottom wall, where the second side wall is disposed at an obtuse angle in reference to the bottom wall, the second side wall having a second opening disposed in line with a viewing angle of the second adjustably fixed camera from the at least three adjustably fixed cameras;
a third side wall adjacent to the first side wall and the bottom wall, where the third side wall is disposed at an obtuse angle in reference to the bottom wall, the third side wall having an opening disposed in line with a viewing angle of the third adjustably fixed camera from the at least three adjustably fixed cameras; and
a fourth side wall adjacent to the bottom wall.

2. The housing of claim 1, where the fourth side wall has attached reinforcement bars along the width of the fourth side wall.

3. The housing of claim 1, comprising at least one mounting bracket operably attached to the fourth side wall for mounting the housing.

4. The housing of claim 1, comprising:
a top wall hingely connected to one of the side walls from the at least four side walls, where in a closed position the top wall is adjacent to each of the at least four side walls; and
a locking mechanism including multiple members, where at least some of the members of the locking mechanism are operably coupled to the top wall.

5. The housing of claim 1, comprising:
a fifth side wall adjacent to the bottom wall, the second side wall and the fourth side wall, the fifth side wall having a first vent opening;
a first handle operably coupled to the fifth side wall;
a sixth side wall adjacent to the bottom wall, the third side wall and the fourth side wall, the sixth side wall having a second vent opening; and
a second handle operably coupled to the sixth side wall.

6. The housing of claim 5, comprising:
at least one fan operably coupled to one of the fifth side wall and the sixth side wall and disposed in line with one of the first vent opening and the second vent opening.

7. The housing of claim 1, comprising:
a first shield operably coupled to the first side wall and positioned as to cover the first opening;
a second shield operably coupled to the second side wall and positioned as to cover the second opening; and
a third shield operably coupled to the third side wall and positioned as to cover the third opening.

8. The housing of claim 7, where the dome, the first shield, the second shield and the third shield are each made from a material chosen from the group consisting of: ballistic grade polycarbonate, polycarbonate, acrylic, styrene and glass.

9. The housing of claim 1, where the bottom wall and the at least four side walls are made of aluminum.

10. The housing of claim 1, comprising a camera mounting bracket disposed inside the housing, where the camera mounting bracket is configured to accept mounting mechanisms from the at least three adjustably fixed cameras and the at least one pan/tilt/zoom camera.

11. The housing of claim 1, comprising:
a CPU box including controls and communications circuitry;
a power supply operably connected to the controls and communications circuitry to power the controls and communications circuitry and the at least three adjustably fixed cameras and the at least one pan/tilt/zoom camera; and
input/output interfaces operably connected to the controls and communications circuitry, where the CPU box, the power supply, and the input/output interfaces are disposed within the housing.

12. The housing of claim 11, where the controls and communications circuitry includes detection logic operably connected to the at least three adjustably fixed cameras and the at least one pan/tilt/zoom camera, where the detection logic is configured to detect the occurrence of a triggering event from a first signal received from at least one of the at least three adjustably fixed cameras and where the detection logic is configured to act upon the triggering event by at least causing the at least one pan/tilt/zoom camera to zoom-in in the direction of the triggering event.

13. An enclosure for multiple surveillance cameras comprising:
a plurality of walls defining a cavity to accommodate at least three adjustably fixed cameras and at least a first portion of a pan/tilt/zoom camera, the plurality of walls including:
a bottom wall having a bottom opening;
a first side wall adjacent to the bottom wall and disposed at an obtuse angle with the bottom wall, the first side wall having edges defining a first aperture, where the first aperture is located such that a first adjustably fixed camera from the at least three adjustably fixed cameras has a substantially unobstructed view through a first shield positioned in relation to the first side wall as to cover the first aperture;
a second side wall adjacent to the bottom wall and disposed at an obtuse angle with the bottom wall, the second side wall having edges defining a second aperture, where the second aperture is located such that a second adjustably fixed camera from the at least three adjustably fixed cameras has a substantially unobstructed view through a second shield positioned in relation to the second side wall as to cover the second aperture;
a third side wall adjacent to the bottom wall and disposed at an obtuse angle with the bottom wall, the third side wall having edges defining a third aperture, where the third aperture is located such that a third adjustably fixed camera from the at least three adjustably fixed cameras has a substantially unobstructed view through a third shield positioned in relation to the third side wall as to cover the third aperture; and
a fourth side wall adjacent to the bottom wall;
a dome protruding through the bottom opening, the dome being configured to house at least a second portion of the at least one pan/tilt/zoom camera.

14. The enclosure of claim 13, comprising a camera mounting bracket disposed inside the cavity, where the camera mounting bracket is configured to accept mounting mechanisms from the at least three adjustably fixed cameras and the at least one pan/tilt/zoom camera.

15. The enclosure of claim 13, the plurality of walls further including:
a top wall hingely connected to the fourth side wall, where in a closed position the top wall is adjacent to the first side wall, the second side wall, and the fourth side wall.

16. The enclosure of claim 15, the plurality of walls further including:
a fifth side wall adjacent to the bottom wall, the second side wall and the fourth side wall; and
a sixth side wall adjacent to the bottom wall, the third side wall and the fourth side wall.

17. The enclosure of claim 13, comprising:
a CPU box including controls and communications circuitry;
a power supply operably connected to the controls and communications circuitry to power the controls and communications circuitry and the at least three adjustably fixed cameras and the at least one pan/tilt/zoom camera; and
input/output interfaces operably connected to the controls and communications circuitry, where the CPU box, the power supply, and the input/output interfaces are disposed within the cavity.

18. The enclosure of claim 17, where the controls and communications circuitry includes detection logic operably connected to the at least three adjustably fixed cameras and the at least one pan/tilt/zoom camera, where the detection logic is configured to detect the occurrence of a triggering event from a first signal received from at least one of the at least three adjustably fixed cameras and where the detection logic is configured to act upon the triggering event by at least causing the at least one pan/tilt/zoom camera to zoom-in in the direction of the triggering event.

19. The enclosure of claim 13, where the dome, the first shield, the second shield and the third shield are each made from a material chosen from the group consisting of: ballistic grade polycarbonate, polycarbonate, acrylic, styrene and glass.
